(19) United States
(12) Patent Application Publication
(10) Pub. No.: US 2010/0292934 A1
(43) Pub. Date: Nov. 18, 2010

(54) EMISSIONS ANALYZER AND METHODS OF USING SAME

(75) Inventors: Joseph L. Stark, Richmond, TX (US); Huzeifa Ismail, Houston, TX (US); Koral B. Johnson, Pasadena, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/778,519

(22) Filed: May 12, 2010

Related U.S. Application Data
(60) Provisional application No. 61/178,808, filed on May 15, 2009.

(51) Int. Cl. G06F 19/00; G01N 31/00; G01F 1/34

(52) U.S. Cl. 702/24; 702/47

(57) ABSTRACT

An apparatus for characterizing emissions includes an emissions analyzer for estimating a concentration of a selected emission of the emission; a flow rate analyzer for estimating a volumetric flow rate of the emission; and a processor in data communication with the emissions analyzer and the flow rate analyzer, the processor including instructions for estimating a mass per time unit value for the selected emission based on the estimated concentration and the estimated volumetric flow rate.

### CROSS REFERENCE TO RELATED APPLICATION

This application claims priority from U.S. Provisional patent Application Ser. No. 61/178,808, filed May 15, 2009.

### BACKGROUND OF THE DISCLOSURE

1. Field of the Disclosure

The disclosure relates generally to systems and methods for selective monitoring of emission.

2. Description of the Related Art

Exhaust, and other fluid streams, generated by engines or machinery generally include one or more emissions such as NOx and CO. The amount or level of these emissions may be of interest because some of these emissions may be viewed as pollutants. Some jurisdictions may require that operators of equipment, machinery, vehicles or vessels monitor and report these emission levels periodically or in real-time. The amount of these emissions in an exhaust may also give an indication as to whether an engine is operating efficiently. Thus, information relating to emission levels may be useful to diagnose engine malfunctions or to improve operating efficiency.

The present disclosure addresses, in part, the need for systems, methods and devices that may be readily deployed in the field to evaluate a source of emissions and to efficiently characterize and report data relating to these emissions.

### SUMMARY OF THE DISCLOSURE

In aspects, the present disclosure provides an apparatus for characterizing an emission or emissions. The apparatus may include an emissions analyzer configured to estimate a concentration of a selected emission; a flow rate analyzer configured to estimate a volumetric flow rate of the emission; and a processor in data communication with the emissions analyzer and the flow rate analyzer. The processor may include instructions for estimating a mass per time unit value for the selected emission based on the estimated concentration and the estimated volumetric flow rate.

In aspects, the present disclosure provides a method for characterizing an emission. The method may include coupling a sampling conduit to a source of the emission; sampling at least a portion of the emission using an emissions analyzer; estimating a concentration of a selected emission using the emissions analyzer; estimating a volumetric flow rate of the emission using a flow rate analyzer; transmitting data representative of the estimated concentration and the estimated volumetric flow rate to a processor; and estimating a mass per time unit value of the selected emission based on the estimated concentration and the estimated volumetric flow rate using the processor.

In aspects, the present disclosure further provides a system for characterizing an emission. The system may include a sampling member, a sensing member, an emission analyzer, a flow rate analyzer, and a processor. The sampling member may have a generally rigid portion that connects with a flue of an emission source. The generally flexible portion of the sensing member may be coupled to the generally rigid portion, and the generally rigid portion and the generally flexible portion may have a conduit formed there along. The sensing member may also have a generally rigid portion configured to connect with a flue of the source. The sensing member may have a differential pressure sensor formed therein. The emission analyzer may be coupled to the conduit of the sensing member and may receive a portion of the emission. The emission analyzer may include a processor programmed to estimate a concentration of a selected component of the emission. The flow rate analyzer may be coupled to the differential pressure sensor with a data conductor. The flow rate analyzer may include a processor programmed to estimate a volumetric flow rate of the emission. The processor may be in data communication with the emission analyzer processor and the flow measurement device processor. The processor may include instructions for estimating a mass per time unit value of the selected component based on the estimated concentration and the estimated volumetric flow rate.

It should be understood that examples of the more important features of the disclosure have been summarized rather broadly in order that detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

The advantages and further aspects of the disclosure will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a schematic illustration of an emissions characterization system in accordance with one embodiment of the present disclosure;

FIG. 2 illustrates one embodiment of an emissions characterization system in accordance with one embodiment of the present disclosure; and

FIG. 3 illustrates one embodiment of CO compensation device utilized with an emissions characterization system in accordance with one embodiment of the present disclosure.

### DETAILED DESCRIPTION OF THE DISCLOSURE

The present disclosure relates to devices and methods for characterizing emissions. The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein.

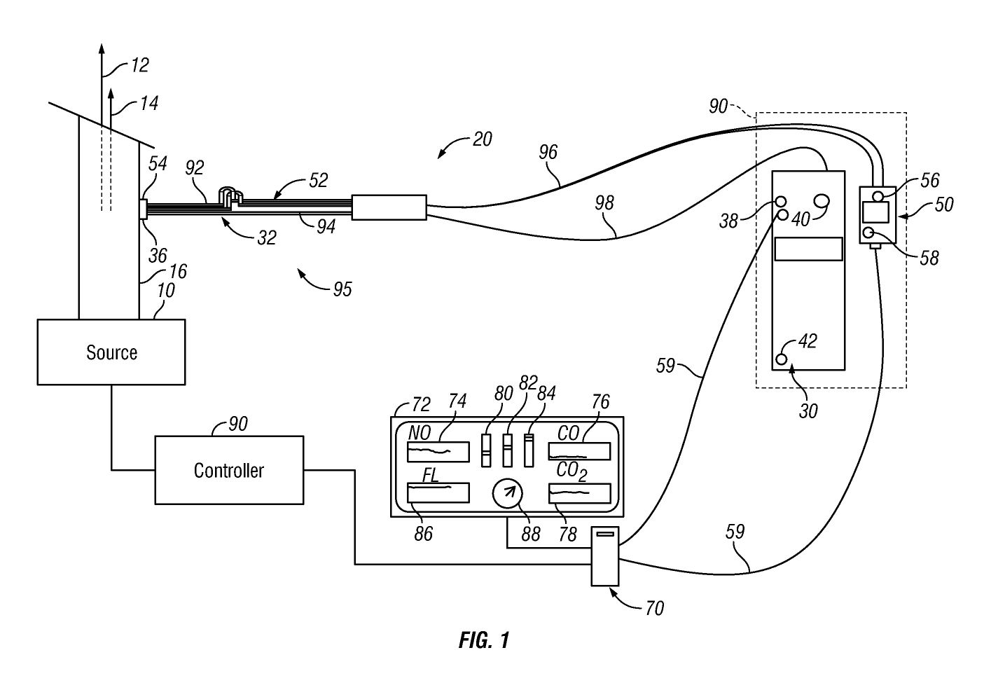

Referring initially to FIG. 1, there is schematically illustrated an emissions source 10 that generates an exhaust having one or more emissions 12 of interest. The term “exhaust,” as used herein includes the materials and by-products of a combustion process. Also, the term “exhaust” may include leaks, evaporation, chemical reactions, vaporization, and other passive gas or vapor streams. Merely for ease of explanation, the present discussion shall generally refer to exhaust as associated with a combustion process.

The emissions source 10 may be an engine or other device that utilizes fuel. A fuel may include any material that burns or otherwise undergoes a transformation that releases energy. For example, fuels may undergo combustion to generate thermal energy. Illustrative fuels include, but are not limited to, biofuels, fuel oils classes 1 through 6, bunker fuels, heavy fuel oil, gasoline, diesel, kerosene, heating oil, and combinations of same. The emissions source 10 may be a fixed or stationary system such as a power plant or a mobile system such as an engine for a marine vessel, car, truck, train, or other land vehicle. This combustion may generate the exhaust 12 that includes one or more emissions 14. The emissions 14 may include gases such as NOₓ, CO, CO₂, and/or particulates. The exhaust 12 may be vented from the emissions source 10 via a stack, flue or other suitable conduit 16. Merely for convenience, such a conduit will be referred to as the flue 16, which represents any suitable structure for conveying the exhaust 12. As noted previously, the exhaust may also be attributed to a fluid (e.g., gas or liquid) stream not associated with combustion; e.g., fumes leaking from a fluid reservoir or tank.

In one embodiment, an emissions characterization system 20 may be utilized to characterize one or more parameters of the exhaust 12, the emission(s) 14, and/or the source 10. By parameter, it is meant features that include, but are not limited to, elemental make-up, a chemical composition, a quantity, volume, a flow rate, particulate size, etc. Parameters of the source 10 may include, but are not limited to, operating speed, efficiency, additive usage, etc. In some aspects, the characterization may include estimating an emissions rate of the emission(s) 14, in particular an emissions rate expressed as a mass per unit time (e.g., grams/hour). To provide such estimates of emissions rates, the system 20 may include an emissions analyzer 30 for determining a composition of the gas emission 14 and a flow rate analyzer 50 for estimating a volumetric flow rate of the exhaust 12. The system may further include a processor 70 programmed to monitor the data acquisition by the analyzer 30 and the flow rate analyzer 50 and to perform one or more tasks by utilizing this data, such tasks including, but not limited to, reporting the data, evaluating source operations utilizing the data, recommending corrective actions, initiating changes in operating parameters, etc.

The emissions analyzer 30 may detect and measure a concentration of one or more emissions 14 in the exhaust 12. The emissions 14 may be a gas and/or a particulate. An illustrative, but not exhaustive, list of gases include CO, NO, NO₂, O₂, CO₂, SO₂, H₂S and CₓH_{y}. The emissions analyzer 30 may receive a sample of the exhaust 12 via a flow line 32. The flow line 32 may tap into the flue 16 via a suitable port 36.

The sampled emissions may be channeled to a suitable sensor or sensors 38 configured to determine the nature of the emission 14. The type of sensor utilized in the emissions analyzer 30 may depend of the desired end use; e.g., diagnostics, monitoring, regulation, compliance reporting, etc. In addition to the sensors 38 that detect the selected gaseous or particulate emissions, in embodiments, one or more environmental sensors may be utilized by the emissions analyzer 30. For example, one or more sensors, labeled with numeral 40, may measure one or more parameters relating to the exhaust 12, such as temperature of the exhaust 12. Also, one or more sensors, labeled with numeral 42, may measure one or more ambient conditions such as pressure or temperature of the air external to and in the vicinity of the flue 16. The emissions analyzer 30 may include one or more processors programmed with suitable instructions to generate data representative of the concentration of one or more selected gases, to process data from the various sensors, to store data, and/or to transmit data. The emissions analyzer 30 may transmit the data continuously, or in “real time,” on-demand and/or at specified intervals.

The flow rate analyzer 50 may estimate the volumetric flow rate of the exhaust 12. The flow rate analyzer 50 may have fluid communication with the exhaust 12 via a flow line 52, which may tap into the flue 12 via a suitable port 54. By fluid communication, it is meant that gas, liquids, or a combination thereof flows to the flow rate analyzer 50. The ports 36 and 54 may be the same port or different ports. Coupled to the flow line 52 is a differential pressure sensor 56. In embodiments, one or more additional sensors may be utilized by the flow rate analyzer 50. For example, one or more sensors, labeled with numeral 58, may measure one or more ambient conditions such as pressure and temperature. The flow rate analyzer 50 may include one or more processors programmed with suitable instructions to generate data representative of the volumetric flow rate by using the differential pressure measurements. The flow rate analyzer 50 may utilize differential pressure sensors, ultrasonic sensors, coriolis flow meters, etc.

The emissions analyzer 30 and the flow rate analyzer 50 may communicate with the processor 70 via cables 59. Alternatively, a wireless communication system may be utilized.

In embodiments, the processor 70 may characterize one or more parameters of the exhaust 12, emissions(s) 14, and/or source 10. In one arrangement, the processor 70 uses preprogrammed instructions to process the emission concentration data generated by the emissions analyzer 30 and the volumetric flow rate data generated by the flow rate analyzer 50 to estimate the emissions rate of the emission(s) 14 as mass per unit time. In one embodiment, the emissions rate data may be reported on a real time or near real time basis to a user. For example, the processor 70 may present the emissions rate data to the user on a display device 72. In one arrangement, the display device may graphically depict the mass per unit time for various gases, e.g., graphs 74, 76, 78. Additionally, environmental data may be presented, e.g., ambient pressure 80, ambient temperature 82, and emissions temperature 84. Further, the display 72 may present flow rate data 86. Still further, in embodiments, the processor 70 may be programmed to determine an operating efficiency of an engine, which may be the source, and present an estimate of the efficiency of the engine. For instance, an indicator 88 may be utilized to present efficiency as a percentage of maximum efficiency. Thus, the processor 70 may provide the user with data suitable to evaluate the operation of the source 10 in real time.

The processor 70 and a controller 90 of the emissions source 10 may operate in a closed-loop fashion to optimize or otherwise control one or more aspects of the operation of the source 10. For example, the processor 70 and/or the controller 90 may include a processor programmed with one or more mathematical models that may be used to evaluate the operating efficiency of the source 10 based on the emissions rate data and other data provided by the processor 70. Based on this evaluation, the processor may recommend one or more corrective actions and/or execute one or more corrective actions. For instance, the processor 70 may adjust an operating speed, vary a fuel/air ratio, and/or vary the rate of injection of an additive. The term “operating efficiency” encompasses any aspect relating to the operation of the source, which includes, but is not limited to, fuel efficiency, reduction of pollutants, etc. Also, the controller 90 and processor 70 may utilize sensors 91 associated with the emission source 10 that provide indications of one or more parameters associated with the source 10 (e.g., operating speed, operating temperatures, fuel mix, etc.)

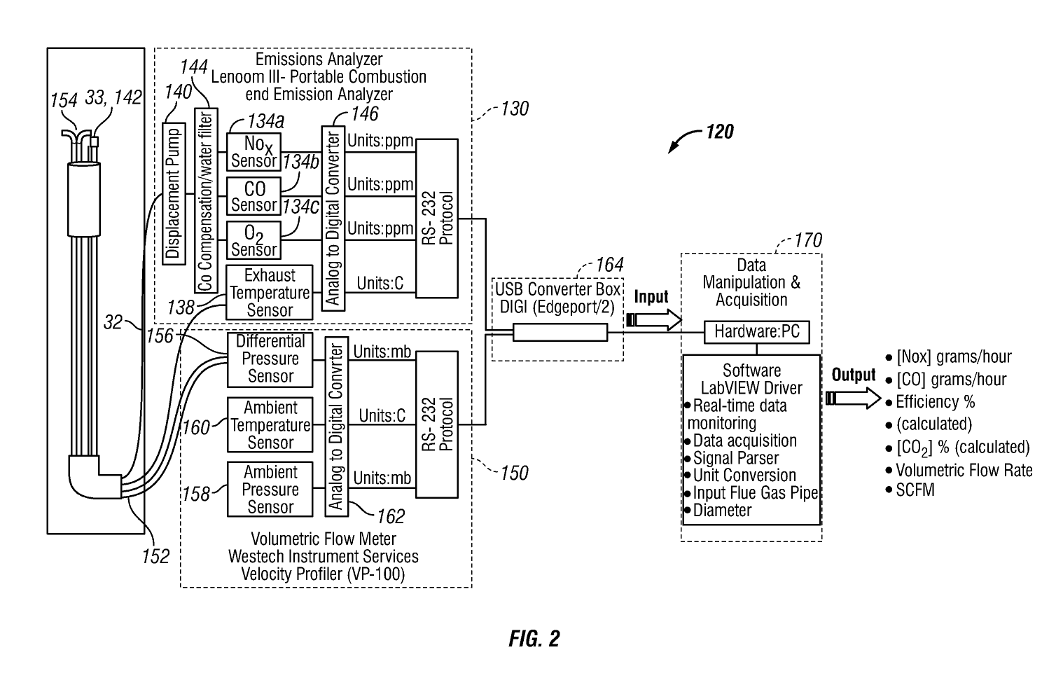

Referring now to FIG. 2, there is shown another embodiment of the emissions characterization system 120 for characterizing a emission. The system 120 may include an emissions analyzer 130 for determining a composition of the emission 14 (FIG. 1), a flow rate analyzer 150 for estimating a volumetric flow rate of the exhaust 12 (FIG. 1), and a processor 170 programmed to estimate a mass per unit time of the emission(s) 14 (FIG. 1).

In the illustrated arrangement, the emissions analyzer 130 measures a concentration of one or more selected gases. The emissions analyzer 130 may receive a sample of the exhaust 12 (FIG. 1) via a flow line 32 having a probe 33. One suitable gas analyzer is the Lancom III gas analyzer offered by AMETEK-LAND. As shown, the emissions analyzer 130 includes sensors 134a, 134b, 134c for detecting NOₓ, CO, and O₂, respectively. Additionally, the emissions analyzer 30 may include a temperature sensor 138 to measure the temperature of the exhaust 12. A suitable temperature sensor may include thermocouples. For sampling the exhaust 12 (FIG. 1), the emissions analyzer 130 may include a pump 140 coupled to the flow line 32. To condition the gas sample, a sintering filter 142 may be positioned at an inlet of the probe 33. Also, the sampled gas may be also conditioned by a CO compensation device 144 that receives the sampled gas from the pump 140. The emissions analyzer 30 may include an A/D converter 146 that digitizes the measurements provided by the sensors 134a-c, 138 and one or more processors (not shown) programmed with suitable instructions to generate data representative of the concentration of one or more selected gases, to process data from the various sensors, to store data and/or to transmit data.

The illustrated flow rate analyzer 150 estimates the volumetric flow rate of the exhaust 12 (FIG. 1). The flow rate analyzer 150 may have fluid communication with the exhaust 12 (FIG. 1) via a flow line 152. In one arrangement, the flow line 152 may include a pitot tube 154 that is operatively connected to a differential pressure sensor 156. One suitable flow rate analyzer is the VP-100 offered by WESTVIEW INSTRUMENT SERVICES. In embodiments, the flow rate analyzer 150 may include an ambient pressure sensor 158 and an ambient temperature sensor 160. The flow rate analyzer 150 may include an A/D converter 162 that digitizes the measurements provided by the sensors 156, 158, 160 and one or more processors programmed with suitable instructions to generate data representative of the volumetric flow rate by using the differential pressure measurements. For example, in arrangement, the flow rate analyzer 150 uses the measurements provided by the differential pressure sensor to calculate or determine a volumetric flow rate. The flow rate analyzer 150 may be preprogrammed with information such as the geometry of the flue (e.g., diameter of the bore or passage).

The emissions analyzer 130 and the flow rate analyzer 150 may communicate with the processor 170 via suitable connections and cables 164, such as USB connections. Other data transmission devices such as wireless and Bluetooth systems may also be utilized.

The processor 170 may be configured to perform a variety of functions, including, but not limited to, the monitoring of data generated by the emissions analyzer 130 and flow rate analyzer 150, controlling the data exchange between the emissions analyzer 130 and the flow rate analyzer 150, and the processing of such data to provide estimates or determinations of various parameters of interest relating to the source 10 (FIG. 1), the exhaust 12 (FIG. 1) and the emission(s) 14 (FIG. 1). The processor 170 may use preprogrammed instructions to process the emission concentration data generated by the emissions analyzer 130 and the volumetric flow rate data generated by the flow rate analyzer 150 to estimate the emissions rate of the emission(s) as well as other relevant data. For example, the processor 170 may calculate or determine the emissions, e.g., NOₓ and CO, in grams per hour, the efficiency of the source 10 as a percentage, the percentage of CO2 in the exhaust 12 (FIG. 1), and the volumetric flow rate. The processor 170 may present this data on display device 72 (FIG. 1) and/or transmit this data to the controller for adjustment of the operating parameters of the source 10 (FIG. 1).

Additionally, in certain embodiments, the processor 170 may be configured to perform a correction of an emissions rate using humidity measurements. For example, referring now to FIG. 1, a humidity sensor 192 may be coupled to the processor 170 via a suitable data conductor 194 or a wireless data transmission system. While the humidity sensor 192 is shown as directly coupled to the processor 170, it should be understood that the humidity sensor 92 may transmit the data to another device such as the flow rate analyzer 150. The humidity data provided by the humidity sensor 192 may be transmitted in real time, transmitted periodically, or recorded and transmitted on-demand. Thus, in one mode of operation, the processor 170 receives the humidity data from the humidity sensor 92 and, using known algorithms and formula, corrects the estimated emission rate using the humidity data.

In embodiments, the emissions characterization systems 20, 120 may be configured to be readily deployable in the field. That is, the systems 20, 120 may be connected to and used with any source capable of generating emissions, whether the source is stationary or mobile. Moreover, the systems 20, 120 may be configured with the type of sensor or sensors needed to detect or measure the emission(s) of interest. As noted previously, these sources may combust fuel, such as class 1 oil, class 2 oil, class 3 oil, class 4 oil, class 5 oil, class 6 oil or mixtures there of; gasoline, ethanol and other fuels generated from an reusable source classified as a biofuel and mixtures there of, biofuels, biodiesel, heavy fuel oil, bunker fuel, power generation fuel, heating oil,—or any hydrocarbon that combusts either through compression, or ignition or in turbines.

Referring to FIG. 1, for example, the emissions analyzer 30 and the flow rate analyzer 30 may be portable units that may be carried in a human wearable pouch or container 90. The flow lines 32 and 52 may each include rigid portions 92, 94 that are assembled as an integrated unit 95 that can be readily manipulated. In one aspect, the rigid portions 92, 94 may be considered the “probe” portion in that these rigid portions 92, 94 enable the sampling and testing of the exhaust 12. Thus, as used herein, the term “probe” encompasses one or more devices that sample the exhaust 12 and/or sense one or more parameters of the exhaust 12. The flow lines 32 and 52 may further include a pliable or flexible portion 96, 98, respectively that terminate at the emissions analyzer 30 and the flow rate analyzer 50, respectively. Because of this flexible connection provided by the flexible portions 96, 98, the container 90 may be moved or positioned as needed by human personnel. It should be appreciated that in such embodiments, the emissions characterization system 20 may be conveyed into a location of interest and each sub-assembly (e.g., rigid portions 82, 84) may be readily deployed by human personnel. In embodiments, the proximity of the rigid portions 82, 84 to the flue 16 may cause an undesirable amount of thermal energy to be conducted across the rigid portions 82, 84. This thermal energy may detrimentally effect equipment such as the flexible portions 96, 98. To dissipate this heat, certain embodiments may include a heat dissipater 196 configured to radiate heat conducted along the rigid portions 82, 84 into the ambient environment. The heat dissipater 196 may include fins, plates or other structures suited to radiate heat.

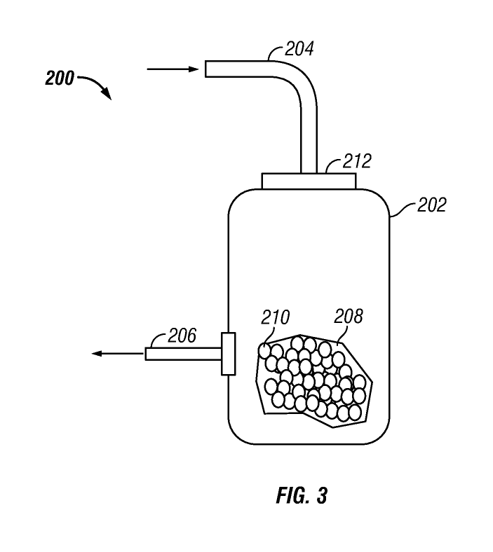

Referring now to FIG. 3, there is shown another embodiment of a CO compensation device 200 that may be used in lieu of the CO compensation device 144 shown in FIG. 2. The CO compensation device 200 may include a flask or bottle portion 202, an inlet 204, and an outlet 206. For clarity, a portion of the flask 202 has been removed to view the interior of the flask 202. The flask 202 may include an interior chamber 208 adapted to receive a desiccant 210. The desiccant 210 may be formulated to absorb one or more selected emissions or items in the exhaust. For example, the desiccant 210 may be configured to absorb water and NOₓ but does not absorb CO. In certain embodiments, the desiccant 210 may include potassium permanganate. In embodiments, the flask 202 may be configured as a sealed body with a removable cap element 212. In one mode of use, the flask 202 is loaded with a charge of desiccant 210. During operation, the desiccant 210 absorbs one or more selected emissions of the exhaust. After a selected period of time, the cap element 212 may be removed from the flask 202 and the desiccant 210 may be taken out and discarded. Thereafter, a fresh charge of desiccant 210 may be added to the flask 202. Thus, in one sense, the CO compensation device 200 may be considered rechargeable with desiccant 210.

From the above, it should be appreciated that the present disclosure includes, in part, an apparatus for characterizing an emission or emissions. The apparatus may include an emissions analyzer configured to estimate a concentration of a selected emission; a flow rate analyzer configured to estimate a volumetric flow rate of the emission; and a processor in data communication with the emissions analyzer and the flow rate analyzer. The processor may include instructions for estimating a mass per time unit value for the selected emission based on the estimated concentration and the estimated volumetric flow rate.

From the above, it should be appreciated that the present disclosure also includes, in part, a method for characterizing an emission. The method may include coupling a sampling conduit to a source of the emission; sampling at least a portion of the emission using an emissions analyzer; estimating a concentration of a selected emission using the emissions analyzer; estimating a volumetric flow rate of the emission using a flow rate analyzer; transmitting data representative of the estimated concentration and the estimated volumetric flow rate to a processor; and estimating a mass per time unit value of the selected emission based on the estimated concentration and the estimated volumetric flow rate using the processor.

From the above, it should be appreciated that the present disclosure further includes, in part, a system for characterizing an emission. The system may include a sampling member, a sensing member, an emission analyzer, a flow rate analyzer, and a processor. The sampling member may have a generally rigid portion that connects with a flue of an emission source. The generally flexible portion of the sensing member may be coupled to the generally rigid portion, and the generally rigid portion and the generally flexible portion may have a conduit formed there along. The sensing member may also have a generally rigid portion configured to connect with a flue of the source. The sensing member may have a differential pressure sensor formed therein. The emission analyzer may be coupled to the conduit of the sensing member and may receive a portion of the emission. The emission analyzer may include a processor programmed to estimate a concentration of a selected component of the emission. The flow rate analyzer may be coupled to the differential pressure sensor with a data conductor. The flow rate analyzer may include a processor programmed to estimate a volumetric flow rate of the emission. The processor may be in data communication with the emission analyzer processor and the flow measurement device processor. The processor may include instructions for estimating a mass per time unit value of the selected component based on the estimated concentration and the estimated volumetric flow rate.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure.

1. An apparatus for characterizing a gas emission, comprising:
a gas emission analyzer configured to estimate a concentration of a selected component of the gas emission;
a flow measurement device configured to estimate a volumetric flow rate of the gas emission; and
an emissions processor in data communication with the gas emission analyzer and the flow measurement device, the processor including instructions for estimating a mass per time unit value for the selected component based on the estimated concentration and the estimated volumetric flow rate.

2. The apparatus of claim 1, wherein the selected component includes at least one selected gas and wherein the gas emission analyzer includes: (i) a probe in fluid communication with the gas emission; and (ii) a processor programmed to generate data representative of the estimated concentration of the at least one selected gas.

3. The apparatus of claim 2, wherein the gas emission analyzer further includes a first temperature sensor configured to measure a temperature of the gas emission and a second temperature sensor configured to measure an ambient temperature.

4. The apparatus of claim 1, wherein the flow measurement device includes: (i) a differential pressure sensor; (ii) an ambient pressure sensor configured to measure an ambient pressure; and (iii) an ambient temperature sensor configured to measure an ambient temperature.

5. The apparatus of claim 1, wherein:
the gas emission analyzer includes a processor programmed to generate data representative of the estimated concentration of a selected component of the gas emission;
the flow measurement device includes a processor programmed to generate data representative of the estimated volumetric flow rate of the gas emission; and
the emissions processor includes instructions enabling communication with the gas emission analyzer processor and the flow rate sensor processor; the emissions processor further including a model for estimating the mass per time unit value of the selected component based on the data representative of the estimated concentration and the data representative of the estimated volumetric flow rate.

6. The apparatus of claim 1, further comprising:
a handle shaped to be human manipulable; and
a sampling member affixed to said handle, the sampling member having: (i) a first conduit configured to convey a portion of the gas emission to the gas emission analyzer; and (ii) a second conduit having a differential pressure sensor formed therein, the differential pressure sensor being in data communication with the flow measurement device.

7. The apparatus of claim 6, further comprising:
a human wearable container, the container being configured to convey the gas emission analyzer processor and the flow measurement device processor.

8. A method for characterizing a gas emission, comprising:
estimating a concentration of a selected component of the gas emission using a gas emission analyzer;
estimating a volumetric flow rate of the gas emission using a flow measurement device; and
estimating a mass per time unit value of the selected component based on the estimated concentration and the estimated volumetric flow rate using an emissions processor.

9. The method of claim 8, further comprising:
adjusting at least one operating parameter of the source of the gas emission in response to the estimated mass per time unit.

10. The method of claim 9, wherein the at least one operating parameter is adjusted until the estimated mass per time unit is below a preset value.

11. The method of claim 8, wherein the selected component includes at least one selected gas and wherein the gas emission analyzer includes: (i) a probe in fluid communication with the gas emission; and (ii) a processor programmed to generate data representative of the estimated concentration of the at least one selected gas.

12. The method of claim 8, wherein the gas emission analyzer further includes a first temperature sensor configured to measure a temperature of the gas emission and a second temperature sensor configured to measure an ambient temperature.

13. The method of claim 8, wherein the flow measurement device includes: (i) a differential pressure sensor; (ii) an ambient pressure sensor configured to measure an ambient pressure; and (iii) an ambient temperature sensor configured to measure an ambient temperature.

14. A system for characterizing a gas emission, comprising:
a sampling member having conduit formed there along;
a differential pressure sensor positioned along the sampling member;
a gas emission analyzer coupled to the conduit, the gas emission analyzer including a processor programmed to estimate a concentration of a selected component of the gas emission;
a flow measurement device in data communication with the differential pressure sensor, the flow measurement device including a processor programmed to estimate a volumetric flow rate of the gas emission; and
an emissions processor in data communication with the gas emission analyzer processor and the flow measurement device processor, the processor including instructions for estimating a mass per time unit value of the selected component based on the estimated concentration and the estimated volumetric flow rate.

15. The system of claim 14 wherein the sampling member includes a generally rigid portion configured to connect with a flue of a gas emitting source, and a generally flexible portion connected to at least one of: (i) the flow measurement device, and (ii) gas emission analyzer.

16. The system of claim 14, wherein the selected component includes at least one selected gas and wherein the gas emission analyzer estimates a concentration of the at least one selected gas.

17. The system of claim 14, wherein the gas emission analyzer further includes a first temperature sensor configured to measure a temperature of the gas emission and a second temperature sensor configured to measure an ambient temperature.

18. The system of claim 14, wherein the flow measurement device includes: (i) an ambient pressure sensor configured to measure an ambient pressure; and (ii) an ambient temperature sensor configured to measure an ambient temperature.
